(19) United States
(12) Patent Application Publication
(10) Pub. No.: US 2009/0066610 A1
(43) Pub. Date: Mar. 12, 2009

(54) Plasma Display Apparatus

(76) Inventors: Tetsuya Sakamoto, Kunitomi (JP); Naoki Itokawa, Kunitomi (JP); Takayuki Kobayashi, Kunitomi (JP); Tomokatsu Kishi, Kunitomi (JP)

Correspondence Address: MCDERMOTT WILL & EMERY LLP, 600 13TH STREET, N.W., WASHINGTON, DC, 20005-3096, US

(21) Appl. No.: 11/920,433

(22) PCT Filed: Aug. 23, 2005
(86) PCT No.: PCT/JP2005/015261

§ 371 Date: Nov. 15, 2007

(51) Int. Cl. G09G 3/28

(52) U.S. Cl. 345/60

(57) ABSTRACT

Provided is a plasma display apparatus capable of reducing power consumption by effectively using charges charged in a plasma display panel and achieving a high luminance by a reduction in reactive power. This plasma display apparatus includes: a plasma display panel in which X electrodes, Y electrodes, and Z electrodes are disposed on a front substrate and address electrodes are disposed on a rear substrate; and an X drive circuit, a Y drive circuit, a Z drive circuit and an address drive circuit for performing discharge light emission by applying a Z pulse between the Z electrode and the X electrode or between the Z electrode and the Y electrode and applying an X (Y) pulse between the X electrode and the Y electrode. The Z drive circuit includes a coil and switches using an LC resonance operation with the capacitance of the plasma display panel, and the Z pulse having a narrow pulse width can be generated by generating a Z pulse in the Z drive circuit.

### TECHNICAL FIELD

The present invention relates to a plasma display apparatus. In particular, it relates to a technology effectively applied to a Z drive circuit of a plasma display panel in which a Z electrode is disposed at a position in a slit between an X electrode and a Y electrode on a front substrate.

### BACKGROUND ART

For example, a plasma display apparatus has a plasma display panel in which X electrodes and Y electrodes are disposed in parallel to each other on a front substrate, address electrodes extending in a direction orthogonal to the X and Y electrodes are disposed on a rear substrate having a discharge space between the front substrate and the rear substrate, and a Z electrode is disposed at a position in a slit between the X and Y electrodes on the front substrate so as to be parallel to the X and Y electrodes. This plasma display panel is controlled by an X drive circuit, a Y drive circuit, an address drive circuit, and a Z drive circuit (for example, refer to Patent Document 1). In particular, a trigger pulse applied from the Z drive circuit to the Z electrode is a rectangular wave having a narrow pulse width because it is required to have high-speed characteristics for discharge.

Patent Document 1: Japanese Patent Application Laid-Open Publication No. 2002-110047

### DISCLOSURE OF THE INVENTION

### Problem to be Solved by the Invention

Meanwhile, in the above-described plasma display apparatus, each driving pulse as shown in FIG. 17 (which is a drawing showing an example of a timing chart of each drive circuit) is applied, for example. In particular, as shown in FIG. 17, since the Z drive circuit applies a rectangular wave having a narrow pulse width to the plasma display panel, a loss occurs in accordance with the capacitance, applied voltage, and frequency of the panel, which causes such problems as an increase in power consumption that does not directly contribute to light emission (reactive power), a decrease in luminance because of being unable to sufficiently ensure power required for light emission due to the increase in reactive power, and an increase in cost due to an increase in circuit size.

To get around these problems, an object of the present invention is to provide a plasma display apparatus capable of reducing power consumption by effectively using electric charges charged in a plasma display panel and achieving a high luminance by reducing reactive power.

The above and other objects and novel characteristics of the present invention will be apparent from the description of this specification and the accompanying drawings.

### Means for Solving the Problems

The typical ones of the inventions disclosed in this application will be briefly described as follows.

In the present invention, an LC resonance drive circuit utilizing the capacitance of a plasma display panel is used to apply a trigger pulse to fourth electrodes (Z electrodes), thereby achieving power saving. In order to achieve high-speed characteristics, an LC resonance time is set so that the trigger pulse ends after the occurrence of a trigger discharge and before the end of a main discharge.

Specifically, the present invention is applied to a plasma display apparatus comprising: a plasma display panel in which a first electrode and a second electrode are disposed in parallel to each other on a front substrate, a third electrode extending in a direction orthogonal to that of the first and second electrodes is disposed on a rear substrate having a discharge space between the front substrate and the rear substrate, and a fourth electrode is disposed at a position in a slit between the first electrode and the second electrode on the front substrate so as to be parallel to the first electrode and the second electrode; and a plurality of drive circuits for applying a first pulse between the fourth electrode and the first electrode or between the fourth electrode and the second electrode and applying a second pulse between the first electrode and the second electrode, thereby performing discharge light emission, and it has the following characteristics.

(1) Among the plurality of drive circuits, a first drive circuit (Z drive circuit) includes a coil and a switch utilizing an LC resonance operation with a capacitance of the plasma display panel, and the first pulse is generated by the first drive circuit.

(2) The first pulse has a pulse width which ends before discharge light emission started by the second pulse ends.

(3) Charging and discharging a charge of the capacitance of the plasma display panel in the LC resonance operation of the first pulse are performed by one switching operation.

(4) A switching time for charging and discharging the charge of the capacitance of the plasma display panel in the LC resonance operation of the first pulse is equal to or shorter than 100 ns.

(5) The first drive circuit has a power supply circuit which applies a positive offset voltage to increase an amplitude of a rising edge of the first pulse.

(6) The first drive circuit has a power supply circuit which applies a negative offset voltage to increase an amplitude of a trailing edge of the first pulse.

(7) The first pulse has a positive polarity.

(8) The first pulse has a negative polarity.

(9) The fourth electrode between the first electrode and the second electrode not performing discharge light emission by the second pulse is at an intermediate potential of the second pulse.

(10) The plasma display apparatus employs an ALIS method.

### EFFECT OF THE INVENTION

The effects obtained by typical aspects of the present invention will be briefly described below.

According to the present invention, the charges charged in the plasma display panel are effectively used by using the LC resonance drive circuit utilizing the capacitance of the plasma display panel. Accordingly, power consumption can be reduced.

Further, according to the present invention, since power required for light emission can be sufficiently ensured by the reduction in reactive power, the high luminance can be achieved.

### BRIEF DESCRIPTION OF THE DRAWINGS

FIG. 1 is a drawing showing an example of a structure of a plasma display apparatus according to an embodiment of the present invention;

FIG. 2 is an exploded perspective view showing an example of a structure of a plasma display panel in the plasma display apparatus according to the embodiment of the present invention;

FIG. 3 is a drawing showing an example of an electrode structure of a front substrate in the plasma display apparatus according to the embodiment of the present invention;

FIG. 4 is a drawing showing an example of a configuration of one frame of an image in the plasma display apparatus according to the embodiment of the present invention;

FIG. 5A is a drawing showing an example of general outlines of a voltage waveform and discharge light emission of each electrode in the plasma display apparatus according to the embodiment of the present invention and FIG. 5B is a drawing showing an example of a cross section of the plasma display panel in the plasma display apparatus according to the embodiment of the present invention;

FIG. 6A is a drawing showing an example of a planar structure of an ALIS four-electrode plasma display panel in the plasma display apparatus according to the embodiment of the present invention and FIG. 6B is a drawing showing an example of a cross section of the ALIS four-electrode plasma display panel in the plasma display apparatus according to the embodiment of the present invention;

FIG. 7A and FIG. 7B are drawings each showing an example of a circuit configuration of a first Z drive circuit in the plasma display apparatus according to the embodiment of the present invention;

FIG. 8 is a drawing showing an example of a timing chart (positive polarity) of the first Z drive circuit in the plasma display apparatus according to the embodiment of the present invention;

FIG. 9 is a drawing showing an example of a timing chart (negative polarity) of the first Z drive circuit in the plasma display apparatus according to the embodiment of the present invention;

FIG. 10A and FIG. 10B are drawings each showing an example of the circuit configuration of a second Z drive circuit in the plasma display apparatus according to the embodiment of the present invention;

FIG. 11 is a drawing showing an example of a timing chart (positive polarity) of the second Z drive circuit in the plasma display apparatus according to the embodiment of the present invention;

FIG. 12A and FIG. 12B are drawings each showing an example of the circuit configuration of a third Z drive circuit in the plasma display apparatus according to the embodiment of the present invention;

FIG. 13 is a drawing showing an example of a timing chart (negative polarity) of the third Z drive circuit in the plasma display apparatus according to the embodiment of the present invention;

FIG. 14A and FIG. 14B are drawings each showing an example of the circuit configuration of a fourth Z drive circuit in the plasma display apparatus according to the embodiment of the present invention;

FIG. 15 is a drawing showing an example of a timing chart (positive polarity) of the fourth Z drive circuit in the plasma display apparatus according to the embodiment of the present invention;

FIG. 16 is a drawing showing an example of a timing chart (negative polarity) of the fourth Z drive circuit in the plasma display apparatus according to the embodiment of the present invention; and

FIG. 17 is a drawing showing an example of a timing chart of each drive circuit in a conventional plasma display apparatus in contrast to the present invention.

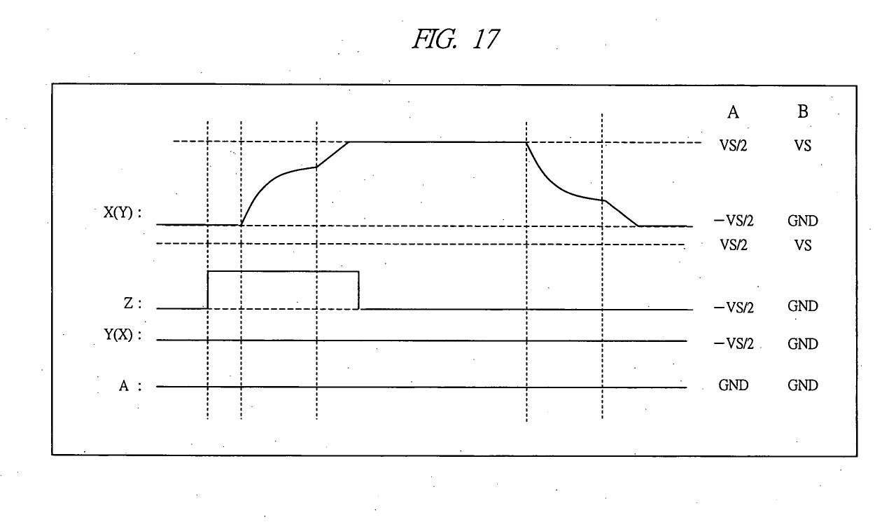

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

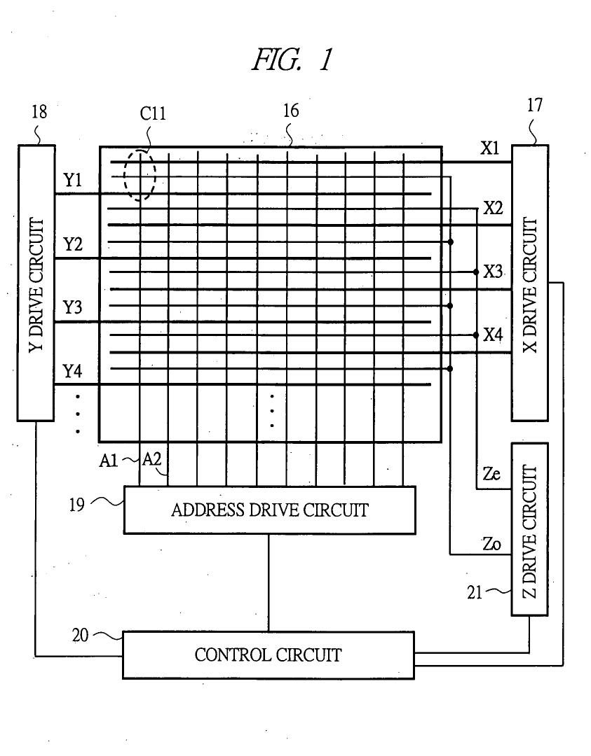

First, an example of a structure of a plasma display apparatus according to an embodiment of the present invention will be described with reference to FIG. 1. FIG. 1 is a drawing showing an example of the structure of the plasma display apparatus.

The plasma display apparatus according to the present embodiment is applied to an example of a four-electrode plasma display apparatus, and it is constituted of, for example, a plasma display panel 16, an X drive circuit 17, a Y drive circuit 18, an address drive circuit 19, a control circuit 20, a Z drive circuit 21 and others.

The control circuit 20 controls the X drive circuit 17, the Y drive circuit 18, the Z drive circuit 21, and the address drive circuit 19. The X drive circuit 17 supplies a predetermined voltage to a plurality of X electrodes X (X1, X2, . . . ). The Y drive circuit 18 supplies a predetermined voltage to a plurality of Y electrodes Y (Y1, Y2, . . . ). The Z drive circuit 21 supplies a predetermined voltage to a plurality of Z electrodes Z (odd-numbered z electrodes Zo and even-numbered Z electrodes Ze). The address drive circuit 19 supplies a predetermined voltage to a plurality of A electrodes A (A1, A2, . . . ). This four-electrode structure includes the address electrodes A, the X electrodes X, the Y electrodes Y, and the Z electrodes Z. Each of the Z electrodes Z is provided between the X electrode X and the Y electrode Y.

In the plasma display panel 16, the X electrodes X, the Z electrodes Z, and the Y electrodes Y form the rows in parallel to each other in a horizontal direction, and the address electrodes A form the columns in a vertical direction. The address electrodes A are provided so as to cross the X electrodes X, the Y electrodes Y, and the Z electrodes Z. The X electrodes X, the Z electrodes Z, and the Y electrodes Y are alternately disposed in a vertical direction. A Y electrode Yi and an address electrode Aj form a two-dimensional matrix of i-th row and j-th column. A display cell C11 is formed of a point of intersection of a Y electrode Y1 and an address electrode A1 and its adjacent Z electrode Zo and X electrode X1. This display cell C11 corresponds to a pixel. With such a two-dimensional matrix, the plasma display panel 16 can display a two-dimensional image. The Z electrode Zo is an electrode assisting a discharge between, for example, the X electrode X1 and the Y electrode Y1, and the Z electrode Ze is an electrode assisting a discharge between, for example, the Y electrode Y1 and an X electrode X2.

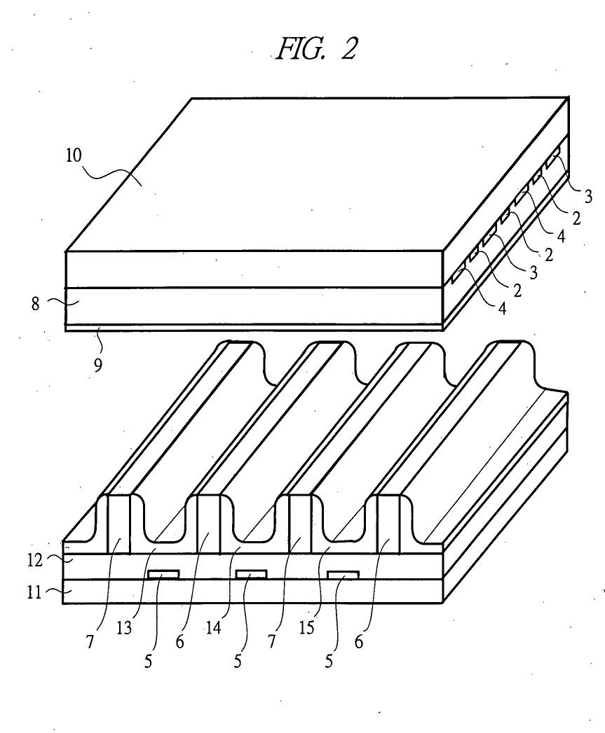

Next, an example of the structure of the plasma display panel in the plasma display apparatus according to the present embodiment will be described with reference to FIG. 2. FIG. 2 is an exploded perspective view showing an example of the structure of the plasma display panel.

In FIG. 2, X electrodes 3 correspond to the X electrodes X in FIG. 1, Y electrodes 4 correspond to the Y electrodes Y in FIG. 1, Z electrodes 2 correspond to the Z electrodes Z in FIG. 1, and address electrodes 5 correspond to the address electrodes A in FIG. 1.

The X electrodes 3, the Y electrodes 4, and the Z electrodes 2 are formed on a front substrate 10 made of glass, and a first dielectric layer 8 is formed thereon for the insulation for a discharge space. On the first dielectric layer 8, a protective layer 9 made of MgO (magnesium oxide) is formed.

On the other hand, the address electrodes 5 are formed on a rear substrate 11 made of glass and disposed so as to face the front substrate 10, and a second dielectric layer 12 is formed on the address electrodes 5. Further, phosphors 13 to 15 are formed thereon. The phosphors 13 to 15 of red, green, and blue are respectively disposed and formed in a stripe shape on the inner walls of barrier ribs (ribs) 6 and 7. By a sustain discharge between the X electrode 3 and the Y electrode 4, the phosphors 13 to 15 are excited to emit lights of the respective colors. In a discharge space between the front substrate 10 and the rear substrate 11, Ne (neon)+Xe (xenon) Penning gas or the like is enclosed.

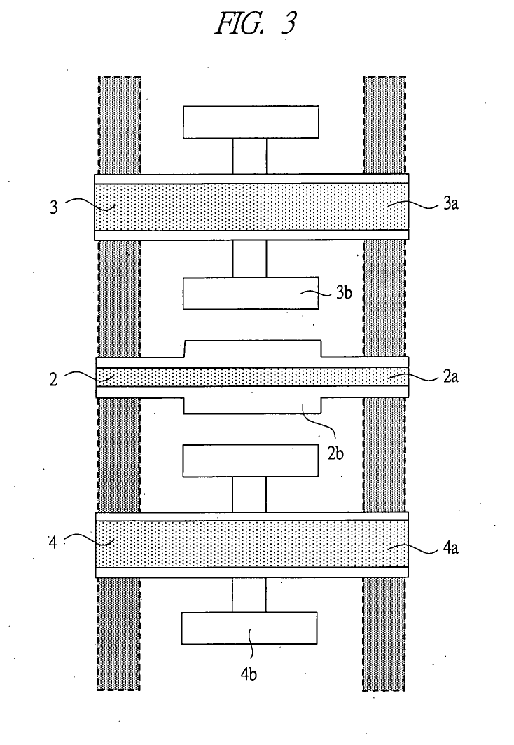

Next, an example of an electrode structure of the front substrate of the plasma display panel will be described with reference to FIG. 3. FIG. 3 is a drawing showing an example of the electrode structure of the front substrate.

The X electrode 3 is constituted of a metal electrode (bus electrode) 3a and a transparent electrode (SUS electrode) 3b. The Y electrode 4 is constituted of a metal electrode 4a and a transparent electrode 4b. The Z electrode 2 is constituted of a metal electrode 2a and a transparent electrode 2b. Here, the Z electrode 2 may is constituted of only the transparent electrode 2b or only the metal electrode 2a.

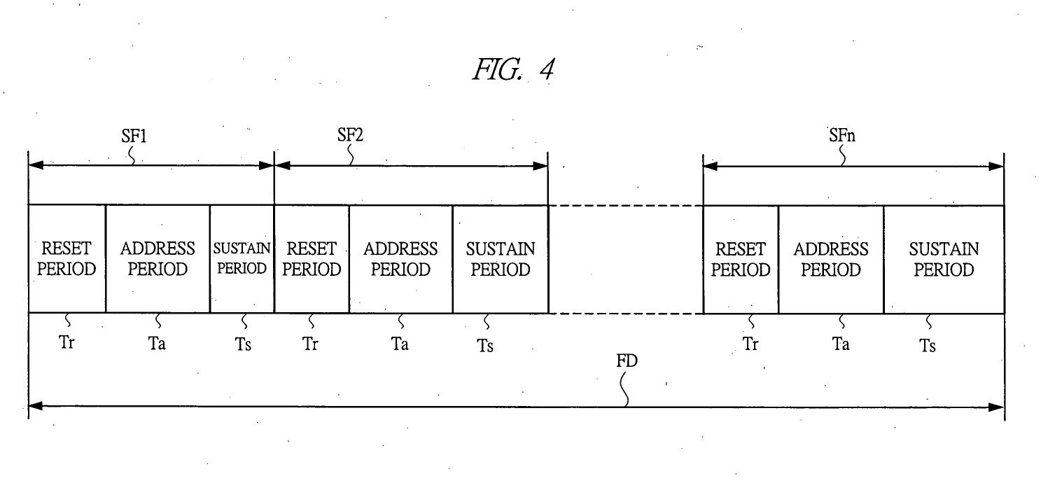

Next, an example of the configuration of one frame of an image in the plasma display panel will be described with reference to FIG. 4. FIG. 4 is a drawing showing an example of the configuration of one frame of an image.

One frame of an image FD is formed of a first sub-frame SF1, a second sub-frame SF2, . . . , and an n-th sub-frame SFn. The n is, for example, 10 and corresponds to the number of grayscale bits.

Each sub-frame SF includes a reset period Tr, an address period Ta, and a sustain (sustain discharge) period Ts. In the reset period Tr, a display cell is initialized. In the address period Ta, with an address discharge between the address electrode A and the Y electrode Y, light emission or non light emission of each cell in the sustain period Ts can be selected. Specifically, scan pulses are sequentially applied to the Y electrodes Y1, Y2, Y3, . . . , and address pulses are applied or not applied to the address electrodes A in accordance with these scan pulses, thereby selecting light emission or non light emission of desired display cells. In the sustain period Ts, a sustain discharge is performed between the X electrode X and the Y electrode Y of the selected display cell by using the Z electrode Z, thereby causing the light emission. The number of light emissions by the sustain pulse between the X electrode X and the Y electrode Y differs among the respective sub-frames SF, which makes it possible to determine a grayscale value.

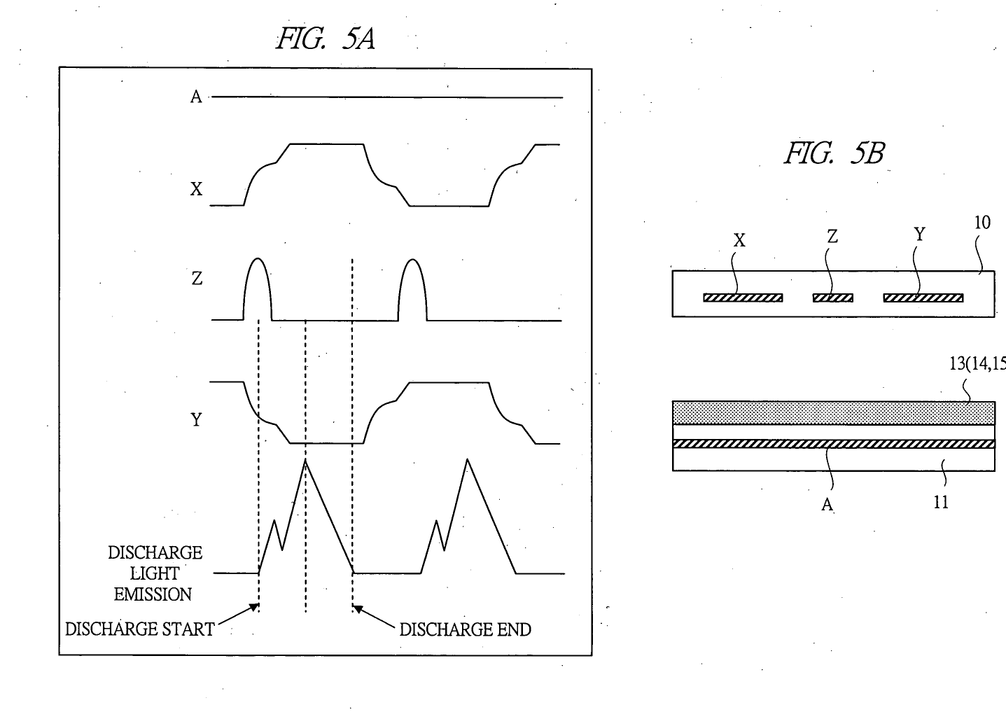

Next, an example of a cross section of the plasma display panel and an example of general outlines of a voltage waveform and discharge light emission of each electrode will be described with reference to FIG. 5A and FIG. 5B. FIG. 5A is a drawing showing an example of general outlines of a voltage waveform and discharge light emission of each electrode, and FIG. 5B is a drawing showing a cross section of the plasma display panel.

As shown in FIG. 5B, the front substrate 10 is provided with the X electrode X, the Y electrode Y and the Z electrode Z and the rear substrate 11 is provided with the address electrode A, and the voltage waveform of each pulse is applied to each of these electrodes. The voltage waveforms of each electrode shown in FIG. 5A represent an example of a discharge operation in the sustain period Ts of the cell selected to be displayed in the address period. A first pulse (Z pulse) equal to or higher than a firing voltage is applied between the Z electrode Z and the Y electrode Y (or between the Z electrode Z and the X electrode X) to generate a trigger discharge. With this trigger discharge as a starting point, a main sustain discharge can be performed by applying a second pulse (X pulse or Y pulse) between the X electrode X and the Y electrode Y.

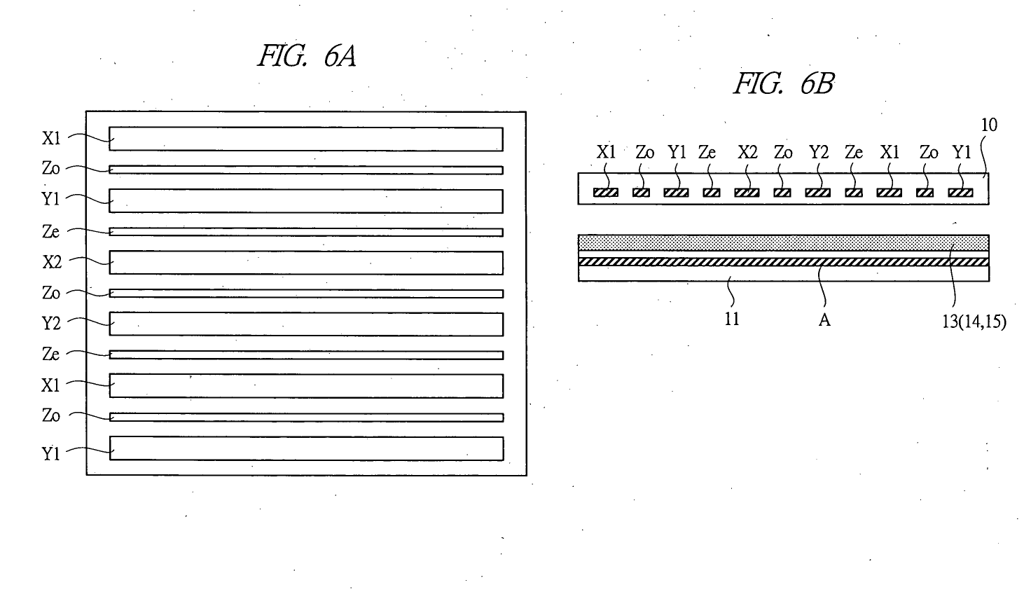

Next, an example of the structure and cross section of an ALIS (Alternate Lighting of Surfaces) four-electrode plasma display panel will be described with reference to FIG. 6A and FIG. 6B. FIG. 6A is a drawing showing an example of a planar structure of the ALIS four-electrode plasma display panel, and FIG. 6B is a drawing showing an example of a cross section thereof.

In FIG. 6A and FIG. 6B, X electrodes X1 represent odd-numbered X electrodes (X1, X3, . . . ) in FIG. 1 and X electrodes X2 represent even-numbered X electrodes (X2, X4, . . . ) in FIG. 1. Also, Y electrodes Y1 represent odd-numbered Y electrodes (Y1, Y3, . . . ) in FIG. 1 and Y electrodes Y2 represent even-numbered Y electrodes (Y2, Y4, . . . ) in FIG. 1. The front substrate 10 is provided with the X electrodes X1 and X2, the Y electrodes Y1 and Y2, the Z electrodes Zo and Ze and the like. The rear substrate 11 is provided with the address electrodes A and the like.

In ALIS driving, odd-numbered frames and even-numbered frames are alternately displayed. In the odd-numbered and even-numbered frames, the position of the light-emitting display cell is changed and the combination of electrodes for use in display is changed.

Specifically, in an odd-numbered frame, the X electrode X1, the Z electrode Zo, and the Y electrode Y1 form one set of display electrodes, and the X electrode X2, the Z electrode Zo, and the Y electrode Y2 form another one set thereof. At this time, the Z electrode Ze is not used as a display electrode, but is used as a barrier electrode for suppressing interference between display cells. When the Z electrode Ze is used as a barrier electrode, the Z electrode Ze is fixed to, for example, the ground.

Then, in an even-numbered frame, the Y electrode Y1, the Z electrode Ze, and the X electrode X2 form one set of display electrodes, and the Y electrode Y2, the Z electrode Ze, and the X electrode X1 form another one set thereof. In this case, the Z electrode Zo serves as a barrier electrode.

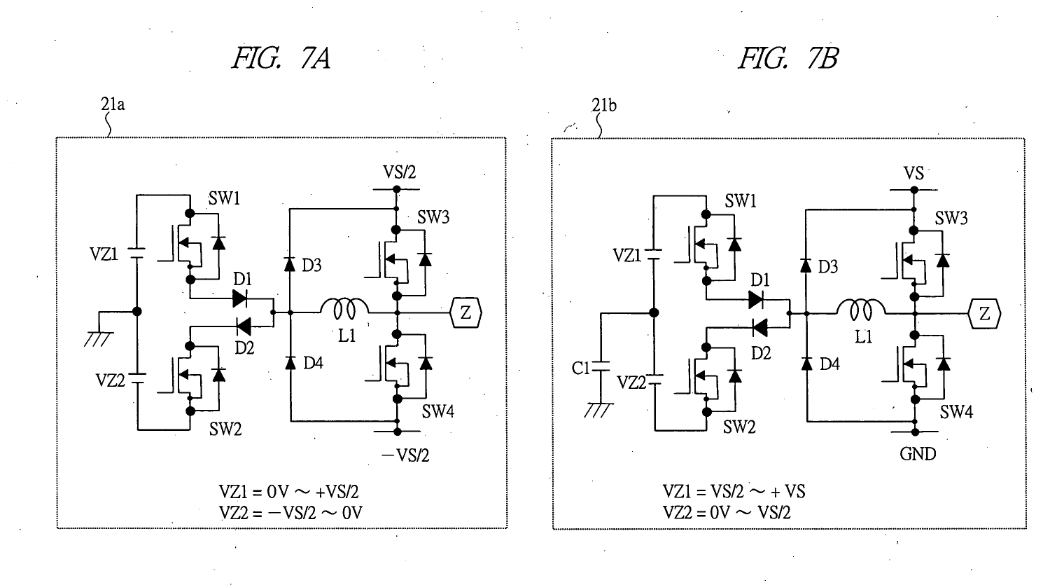

Next, examples of circuit configurations and timing charts of first to fourth Z drive circuits will be described with reference to FIG. 7 to FIG. 16. Note that the X drive circuit, the Y drive circuit, and the address drive circuit have a circuit configuration and timing chart similar to the conventional ones, and operation waveforms thereof (X pulse, Y pulse, and A pulse) are as shown in each drawing.

A Z drive circuit 21a shown in FIG. 7A is constituted of a coil L1, switches SW1 to SW4, diodes D1 to D4, power supplies VZ1 (0V to +VS/2), VZ2 (−VS/2 to 0V), VS/2, −VS/2, and others.

The switches SW1 to SW4 are each formed of a MOSFET element and a diode is connected between the source and the drain thereof. The power supply VZ1 and the power supply VZ2 connected in series with an intermediate potential being grounded are connected between the drain of the switch SW1 and the source of the switch SW2. The source of the switch SW1 is connected to one end of the coil L1 via the forward-connected diode D1. The one end of the coil L1 is connected to the drain of the switch SW2 via the forward-connected diode D2.

The drain of the switch SW3 is connected to the power supply VS/2. The source of the switch SW4 is connected to the power supply −VS/2. The source of the switch SW3 and the drain of the switch SW4 are commonly connected to the other end of the coil L1, and this common connecting point serves as an output terminal of a Z pulse. The diode D3 is reversely connected from the power supply VS/2 to the one end of the coil L1. The diode D4 is reversely connected from the one end of the coil L1 to the power supply −VS/2.

In particular, this Z drive circuit 21a is conventionally constituted of only the switches SW3 and SW4. In the present embodiment, however, it is constituted of the coil L1 and the switches SW1 to SW4 for utilizing an LC resonance operation with the capacitance of the plasma display panel 16 and a Z pulse is generated and applied to the plasma display panel 16. In the switches SW1 and SW2 serving as Z power recovery switches, the MOSFET elements are disposed in parallel to each other. In the coil L1 serving as a resonance coil, a path for charging and discharging the capacitance of the plasma display panel 16 is disposed as a common single line.

A Z drive circuit 21b shown in FIG. 7B is, as with FIG. 7A, constituted of the coil L1 and the switches SW1 to SW4 for utilizing an LC resonance operation with the capacitance of the plasma display panel 16. FIG. 7B is different from FIG. 7A in that a capacitor C1 for power saving circuit is connected between a connecting portion of the power supply VZ1 (VS/2 to +VS) and the power supply VZ2 (0V to VS/2) and GND and the switches SW3 and SW4 are connected to the power supply VS and GND, respectively.

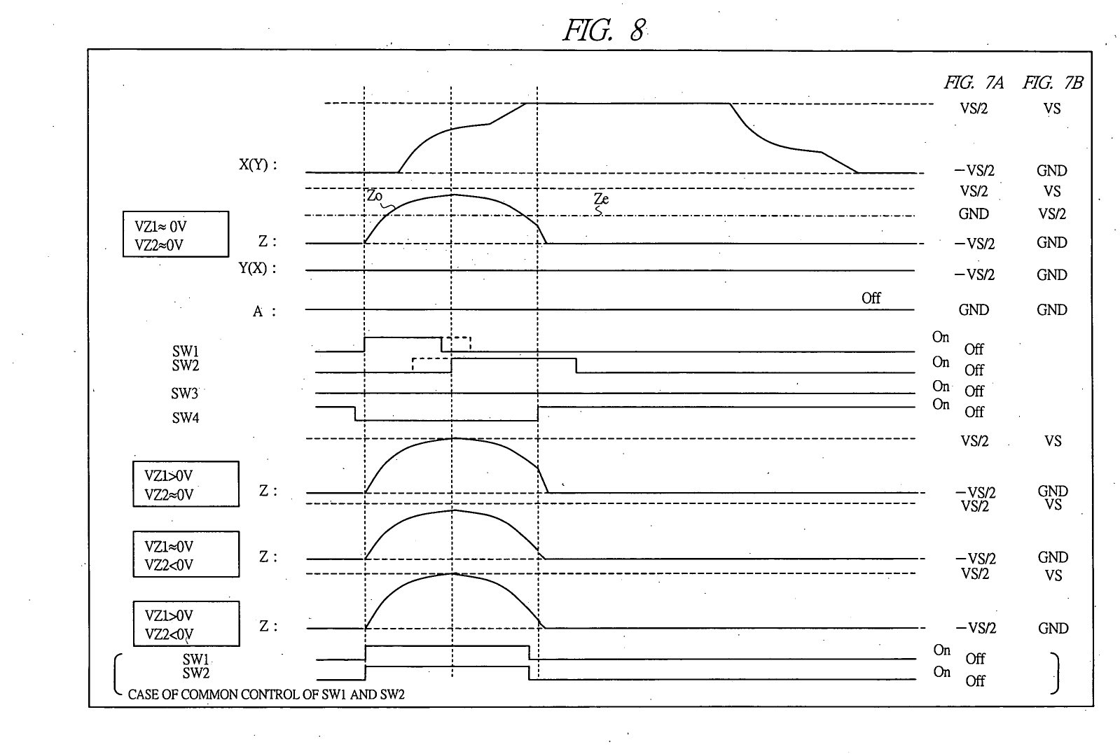

In the Z drive circuits 21a and 21b shown in FIG. 7A and FIG. 7B, as shown in FIG. 8, under the condition of VZ1≈0V and VZ2≈0V, prior to the rise of an X (Y) pulse, the switch SW1 is first turned ON to increase the voltage of a Z pulse. Subsequently, the switch SW2 is turned ON (at this time, SW1 is turned OFF) to drop the Z pulse reaching near a maximum value. Thereafter, an X (Y) pulse is raised to a maximum value. Then, the switch SW4 is turned ON to drop the Z pulse to the original voltage. In this manner, a Z pulse (positive polarity) having a narrow pulse width can be generated.

In order to achieve high-speed characteristics, this Z pulse having a narrow pulse width is set to have a pulse width which ends before the discharge light emission started by an X (Y) pulse ends. By way of example only, the pulse width is on the order of about 100 ns to 1000 ns. The charging to the panel capacitance is performed on the rising edge of this Z pulse, and the discharge from the panel capacitance is performed on the trailing edge thereof. A switching time between the switch SW1 and the switch SW2 for charge and discharge of the charge of this panel capacitance is equal to or shorter than 100 ns.

Here, turning the switches SW1 and SW2 ON/OFF may be performed in a manner as represented by broken lines such that the switch SW2 is first turned ON and then the switch SW1 is turned OFF. Also, the timing of turning the switches SW1, SW2, and SW4 ON is not restricted to that before the rising edge of the X (Y) pulse, but may be the simultaneous timing or that after the rising edge.

Also, under the condition of VZ1>0V and VZ2≈0V, the maximum voltage value reaches VS/2 (FIG. 7A) or VS (FIG. 7B). Under the condition of VZ1≈0V and VZ2<0V, the amount of dropping the voltage to the original voltage is increased. Further, under the condition of VZ1>0V and VZ2<0V, both of them are possible.

Furthermore, in the case of common control of the switch SW1 and the switch SW2, when the switches SW1 and SW2 are turned ON, the voltage of the Z pulse can be increased at this timing of rising, and when the switches SW1 and SW2 are turned OFF, the voltage can be dropped to the original voltage at this timing of trailing. In this case, charging and discharging the charge of the panel capacitance in an LC resonance operation of the Z pulse can be performed by only one switching operation.

Still further, as for the Z pulse, since the Z electrodes Zo and Ze are provided in order to alternately display an odd-numbered frame and an even-numbered frame in ALIS driving, when a pulse indicated by a solid line as shown in FIG. 8 is applied to the Z electrode Zo between the X electrode and the Y electrode performing the discharge light emission by an X (Y) pulse, an intermediate potential (GND in the Z drive circuit 21a of FIG. 7A and VS/2 in the Z drive circuit 21b of FIG. 7B) indicated by a one-dot-chain line shown in FIG. 8 is applied to the Z electrode Ze between the X electrode and the Y electrode not performing the discharge light emission.

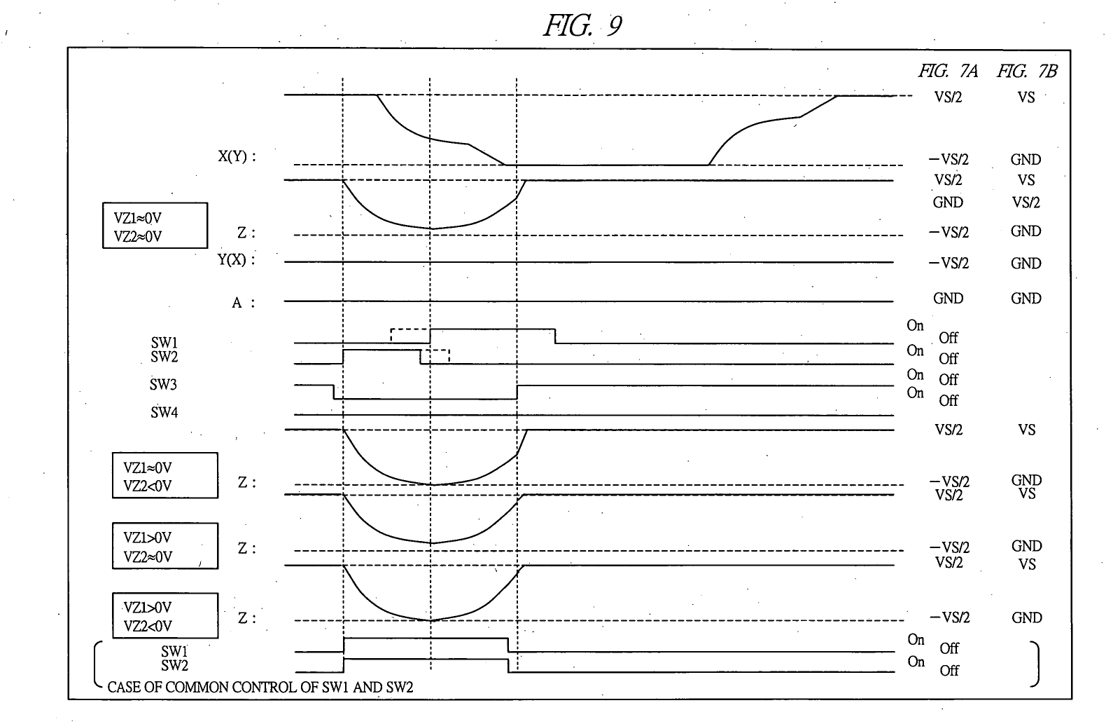

In the case of FIG. 8, the Z pulse is a positive pulse that is convex to a plus side. Conversely, as shown in FIG. 9, the Z pulse can be a negative pulse that is convex to a minus side. In this case, for example, under the condition of VZ1≈0V and VZ2≈0V, prior to dropping an X (Y) pulse, the switch SW2 is first turned ON to drop the voltage of the Z pulse. Subsequently, the switch SW1 is turned ON (at this time, the switch SW2 can be in an OFF or ON state) to raise the Z pulse reaching near a minimum value. Thereafter, the X (Y) pulse is dropped to the minimum value. Then, the switch SW3 is turned ON, and the Z pulse is raised to the original voltage at this timing of rising. In this manner, a Z pulse (negative polarity) having a narrow pulse width can be generated. Further, the timing of turning the switches SW1, SW2, and SW3 ON is not restricted to that before the trailing edge of the X (Y) pulse, but may be the simultaneous timing or that after the trailing edge.

Also, under the condition of VZ1≈0V and VZ2<0V, the minimum voltage value reaches −VS/2 (FIG. 7A) or GND (FIG. 7B). Under the condition of VZ1>0V and VZ2≈0V, the amount of raising the voltage to the original voltage is increased. Further, under the condition of VZ1>0V and VZ2<0V, both of them are possible. Still further, common control of the switch SW1 and the switch SW2 can be performed.

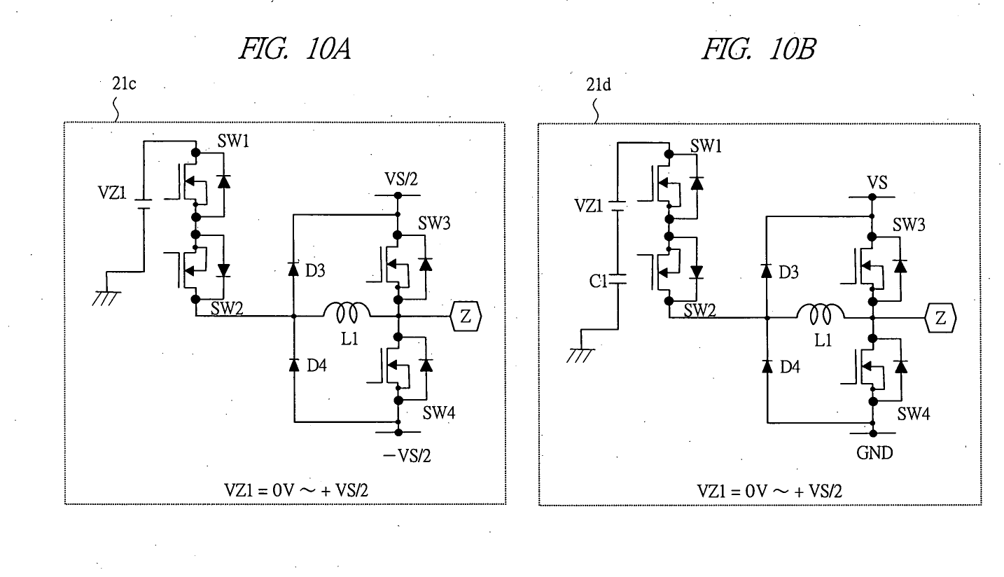

Z drive circuits 21c and 21d shown in FIG. 10A and FIG. 10B are different from the circuit configuration of FIG. 7A and FIG. 7B in the following points. That is, in the switches SW1 and SW2 serving as switches for Z power recovery, MOSFET elements are disposed in series. Further, as the power supply VZ1 (0V to +VS/2) to which the switches SW1 and SW2 are connected, for a Z-pulse voltage offset, a plus power supply circuit that applies a positive offset voltage so as to increase the amplitude of the rising edge is used. In the Z drive circuits 21c and 21d of FIG. 10A and FIG. 10B, since the MOSFET elements are connected in series, the diodes D1 and D2 in the parallel configuration of FIG. 7A and FIG. 7B are not required. Accordingly, the number of components to be used is reduced, which leads to the cost reduction. However, since the power supply for Z-pulse voltage offset is on a plus side only, a peak value of the Z-voltage pulse is limited.

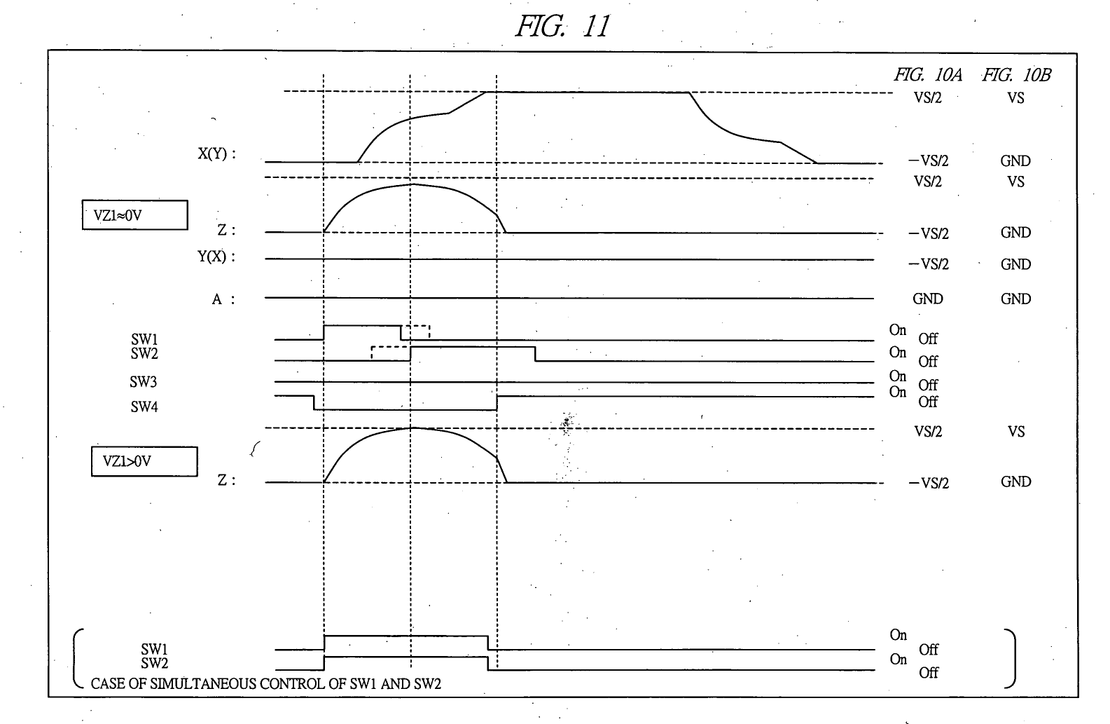

In the Z drive circuits 21c and 21d shown in FIG. 10A and FIG. 10B, as shown in FIG. 11, under the condition of VZ1≈0V, the situation is identical to that under the condition of VZ1≈0V and VZ2≈0V in FIG. 8. Also, under the condition of VZ1>0V, the situation is identical to that under the condition of VZ1>0V and VZ2≈0V in FIG. 8. Accordingly, a Z pulse (positive polarity) having a narrow pulse width can be generated in the similar manner. Also in the Z drive circuits 21c and 21d shown in FIG. 10A and FIG. 10B, the timing as shown in FIG. 9 is possible. In this case, a Z pulse (negative polarity) having a narrow pulse width can be generated.

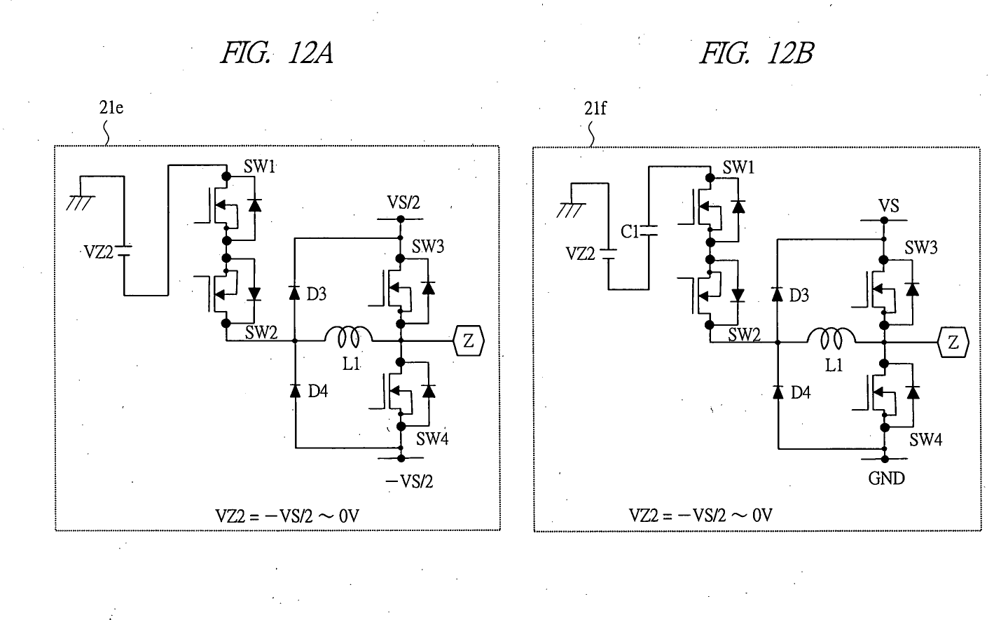

Z drive circuits 21e and 21f shown in FIG. 12A and FIG. 12B are different from the circuit configuration of FIG. 10A and FIG. 10B in the following points. That is, as the power supply VZ2 (−VS/2 to 0V) to which the switches SW1 and SW2 are connected, for a Z-pulse voltage offset, a minus power supply circuit that applies a negative offset voltage so as to increase the amplitude of the trailing edge is used. Accordingly, since the power supply for Z-pulse voltage offset is on a minus side only, a peak value of the Z-voltage pulse is limited.

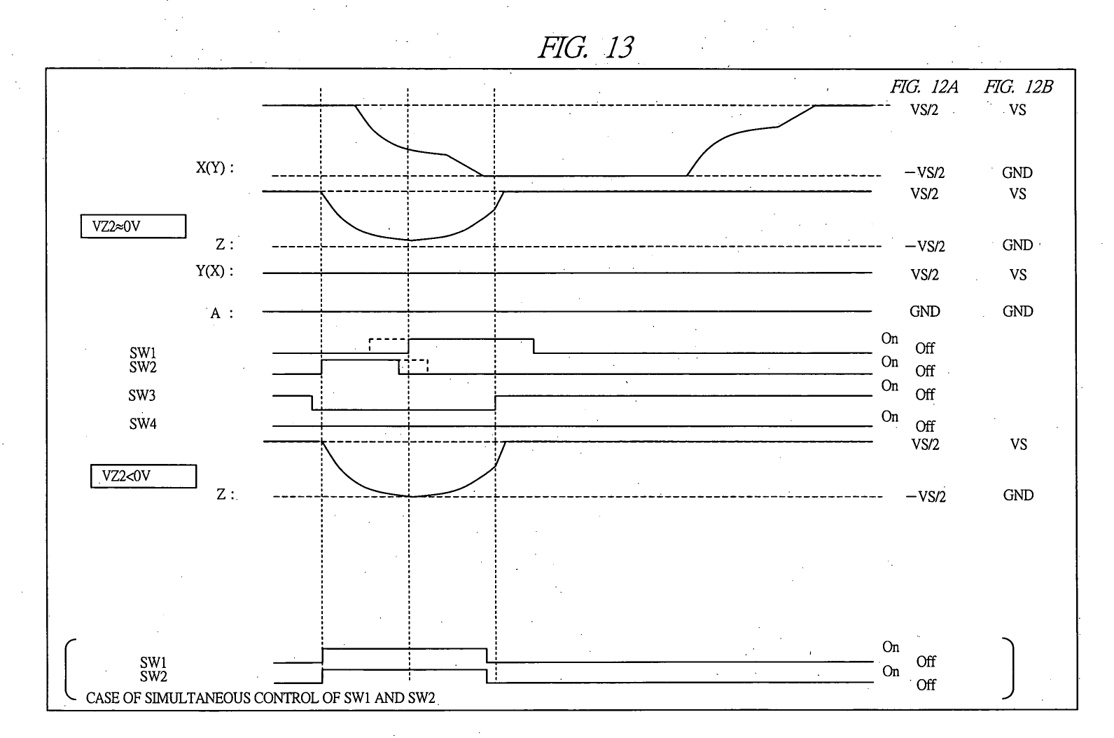

In the Z drive circuits 21e and 21f shown in FIG. 12A and FIG. 12B, as shown in FIG. 13, by using a negative pulse convex to a minus side, a Z pulse (negative polarity) having a narrow pulse width can be generated. More specifically, as for the waveform in FIG. 13, under the condition of VZ2≈0V, the situation is identical to that under the condition of VZ1≈0V and VZ2≈0V in FIG. 9. Also, under the condition of VZ2>0V, the situation is identical to that under the condition of VZ1≈0V and VZ2<0V in FIG. 9. Also in the Z drive circuits 21e and 21f shown in FIG. 12A and FIG. 12B, the timing as shown in FIG. 8 is possible. In this case, a Z pulse (positive polarity) having a narrow pulse width can be generated.

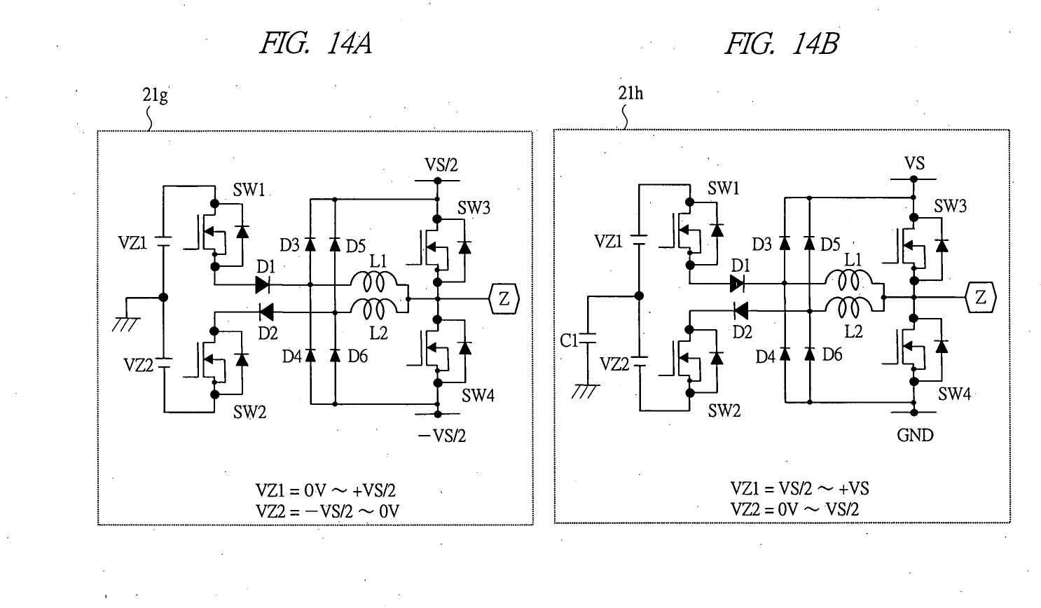

Z drive circuits 21g and 21h shown in FIG. 14A and FIG. 14B are different from the circuit configuration of FIG. 7A and FIG. 7B in the following points. That is, in coils L1 and L2 serving as resonance coils, paths of charging and discharging the capacitance of the plasma display panel 16 are disposed in two different lines. Accordingly, diodes D3 to D6 are connected between each of the coils L1 and L2 and each of the power supplies VS/2 and −VS/2. In the Z drive circuits 21g and 21h of FIG. 14A and FIG. 14B, with the two lines of the resonance coils, a coil value for use in Z-pulse rising (charging to the panel capacitance) and a coil value for use in Z-pulse trailing (discharging from the panel capacitance) can be made different. Therefore, each of the LC resonance times can be independently adjusted and the optimum driving can be achieved. However, since the number of components is increased, cost will be increased.

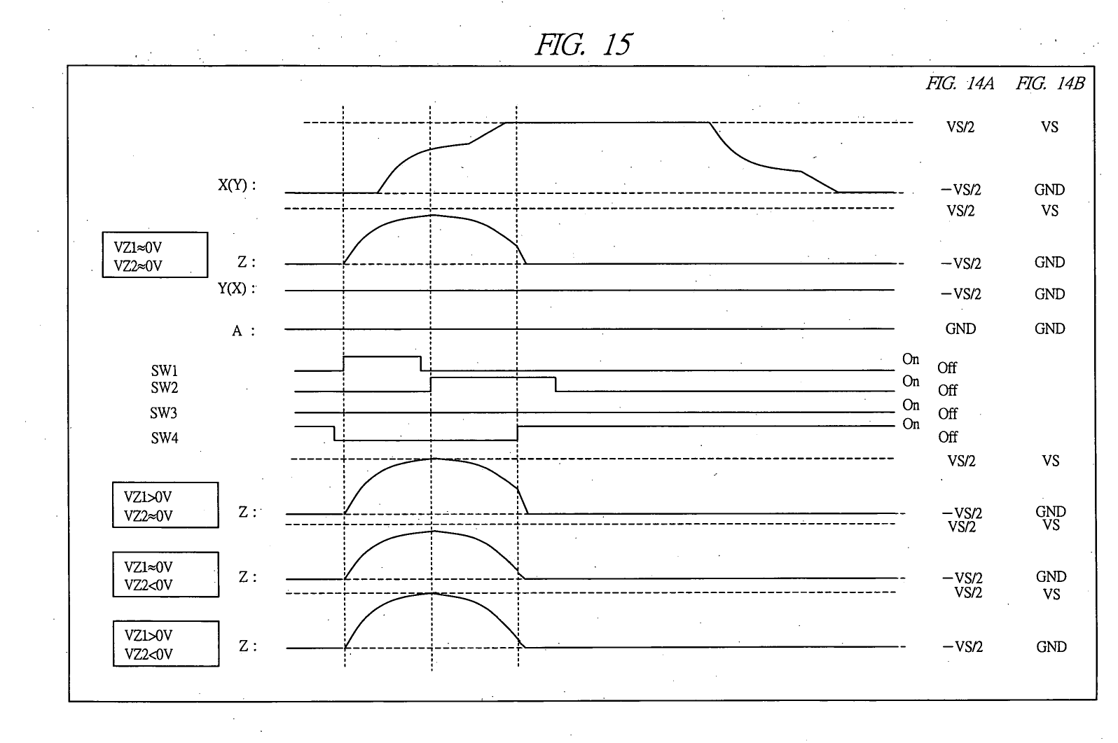

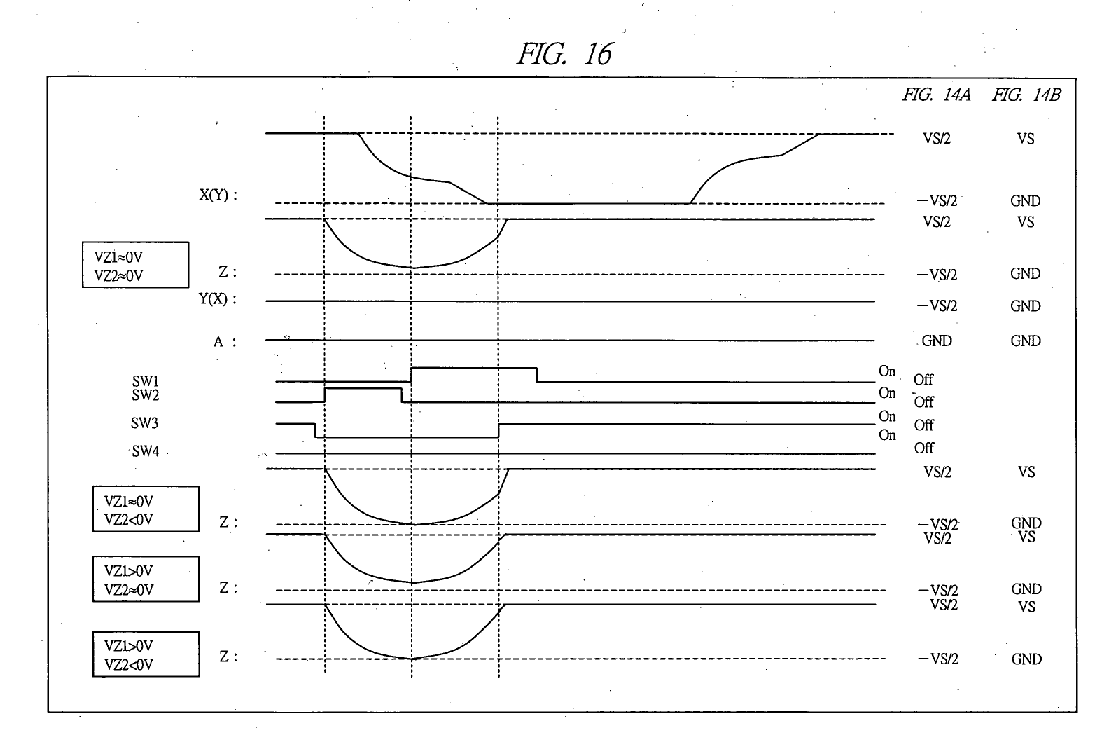

In the Z drive circuits 21g and 21h shown in FIG. 14, as shown in FIG. 15, the situation is identical to that under respective conditions in FIG. 8 described above, and a Z pulse (positive polarity) having a narrow pulse width can be generated in the similar manner. Also, as shown in FIG. 16, the situation is identical to that under respective conditions in FIG. 9 described above, and a Z pulse (negative polarity) having a narrow pulse width can be generated in the similar manner.

As described in the foregoing, according to the present embodiment, the plasma display apparatus includes: the plasma display panel 16 in which the X electrodes 3, the Y electrodes 4, and the Z electrodes 2 are disposed on the front substrate 10 and the address electrodes 5 are disposed on the rear substrate 11; and the X drive circuit 17, the Y drive circuit 18, the Z drive circuit 21 (21a to 21h) and the address drive circuit 19 for performing discharge light emission by applying a Z pulse between the Z electrode 2 and the X electrode 3 or between the Z electrode 2 and the Y electrode 4 and applying an X (Y) pulse between the X electrode 3 and the Y electrode 4, wherein the Z drive circuit 21 is constituted of the coils L1 and L2 and the switches SW1 to SW4 utilizing an LC resonance operation with the capacitance of the plasma display panel 16, and a Z pulse can be generated in the Z drive circuit 21. Therefore, since the Z pulse having a narrow pulse width can be generated, the following effects can be obtained.

That is, the charges charged in the plasma display panel 16 are effectively used by using the LC resonance drive circuit utilizing the capacitance of the plasma display panel 16. Accordingly, power consumption can be reduced. Further, since power required for light emission can be sufficiently ensured by the reduction in reactive power, the high luminance can be achieved.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention relates to a plasma display apparatus. In particular, it effectively applied to a Z drive circuit of a plasma display panel in which a Z electrode is disposed at a position in a slit between an X electrode and a Y electrode on a front substrate.

1. A plasma display apparatus comprising:
a plasma display panel in which a first electrode and a second electrode are disposed in parallel to each other on a front substrate, a third electrode extending in a direction orthogonal to that of the first and second electrodes is disposed on a rear substrate having a discharge space between the front substrate and the rear substrate, and a fourth electrode is disposed at a position in a slit between the first electrode and the second electrode on the front substrate so as to be parallel to the first electrode and the second electrode; and
a plurality of drive circuits for applying a first pulse between the fourth electrode and the first electrode or between the fourth electrode and the second electrode and applying a second pulse between the first electrode and the second electrode, thereby performing discharge light emission,
wherein, among the plurality of drive circuits, a first drive circuit includes a coil and a switch utilizing an LC resonance operation with a capacitance of the plasma display panel, and
the first pulse is generated by the first drive circuit.

2. The plasma display apparatus according to claim 1,
wherein the first pulse has a pulse width which ends before discharge light emission started by the second pulse ends.

3. The plasma display apparatus according to claim 1,
wherein charging and discharging a charge of the capacitance of the plasma display panel in the LC resonance operation of the first pulse are performed by one switching operation.

4. The plasma display apparatus according to claim 1,
wherein a switching time for charging and discharging the charge of the capacitance of the plasma display panel in the LC resonance operation of the first pulse is equal to or shorter than 100 ns.

5. The plasma display apparatus according to claim 1,
wherein the first drive circuit has a power supply circuit which applies a positive offset voltage to increase an amplitude of a rising edge of the first pulse.

6. The plasma display apparatus according to claim 1,
wherein the first drive circuit has a power supply circuit which applies a negative offset voltage to increase an amplitude of a trailing edge of the first pulse.

7. The plasma display apparatus according to claim 1,
wherein the first pulse has a positive polarity.

8. The plasma display apparatus according to claim 1,
wherein the first pulse has a negative polarity.

9. The plasma display apparatus according to claim 1,
wherein the fourth electrode between the first electrode and the second electrode not performing discharge light emission by the second pulse is at an intermediate potential of the second pulse.

10. The plasma display apparatus according to claim 1,
wherein the plasma display apparatus employs an ALIS method.
